(19) United States
(12) Patent Application Publication
(10) Pub. No.: US 2025/0359572 A1
(43) Pub. Date: Nov. 27, 2025

(54) STABLE COMPOSITIONS

(71) Applicant: Steuben Foods, Inc., Elma, NY (US)

(72) Inventor: Obas Frantz-Lairy, Buffalo, NY (US)

(73) Assignee: Steuben Foods, Inc., Elma, NY (US)

(21) Appl. No.: 19/219,787

(22) Filed: May 27, 2025

Related U.S. Application Data
(60) Provisional application No. 63/651,784, filed on May 24, 2024.

(51) Int. Cl. A23L 9/20; A23C 11/10; A23J 1/00; A23J 3/14; A23L 29/231

(52) U.S. Cl. CPC A23L 9/24; A23C 11/103; A23J 1/006; A23J 3/14; A23L 29/231

(57) ABSTRACT

Provided are healthier, cleaner stable compositions and methods of producing stable compositions where feathering is inhibited when a stable composition is added to beverages such as coffee. The stable composition may be plant-based and may be produced by combining protein and pectin in accordance with the methods of the present disclosure. The pectin may be sugar beet pectin. The protein may be a plant protein, such as a cashew protein from a cashew concentrate. A stable composition may have only three ingredients, including water, plant protein-containing concentrate and pectin and may be free of buffering agents, emulsifiers, added oils, gums or other stabilizing agents.

### FIELD

The present disclosure relates to stable compositions comprising pectin and protein.

### BACKGROUND

Creamers are widely used as whitening agents and to modify texture for beverages such as coffee and tea. Many consumers are using non-dairy creamers for a variety of reasons, including health and environmental sustainability. In general, there is a growing demand for plant-based alternatives in the food industry. Many plant-based products, however, do not perform as well as their dairy counterparts. For example, plant-based creamers that contain protein tend to coagulate, or feather, when added to hot, acidic beverages like coffee.

A primary stability challenge associated with plant-based coffee creamers is often a problem known as “feathering.” In the context of plant-based coffee creamers, feathering refers to the denaturation and aggregation of proteins in the creamer, triggered by the low pH of the coffee, which may have a pH between approximately 4 to 5.5, elevated water temperature, and the presence of calcium and magnesium ions. This leads to an undesirable appearance, like curdled milk. Feathering is a well-known problem in dairy and plant-based coffee inclusions such as creamers, barista, and liquid milk beverages.

To improve the stability of proteins in plant-based creamers, stabilizers that include gums or chemicals compounds such as emulsifiers (e.g., lecithin), hydrocolloid systems such as guar gum and gellan gum, and buffering agents such as dipotassium phosphate and sodium citrate are typically added to the creamer formulation. Often, these stabilizers are viewed negatively by consumers and are not considered to be “clean label” ingredients. Consumers generally prefer fewer ingredients in food products, particularly when the added ingredients are not readily recognizable to the consumer or are associated with health problems. For example, dipotassium phosphate, while approved for use in food products by the U.S. Food and Drug Administration (FDA), is associated with kidney problems and is not recommended for use by those who have kidney disease.

### SUMMARY

The present disclosure provides healthier, cleaner stable compositions and methods for producing stable compositions where feathering is inhibited when a stable composition is added to beverages such as coffee. The stable composition may be plant-based and may be produced by combining protein and pectin in accordance with the methods of the present disclosure. The pectin may be sugar beet pectin. The protein may be a plant protein, such as a cashew protein from a cashew concentrate. In some embodiments, the present disclosure may have only three ingredients, including water, protein-containing concentrate and pectin and may be free of buffering agents, emulsifiers, added oils, gums or other stabilizing agents.

In some embodiments, a formulation for a stable composition may include water, cashew protein-containing concentrate, sugar beet pectin, citric acid and potassium hydroxide as pH control agents and natural flavors. In some embodiments, to produce a stable composition, the pH of a protein and pectin mixture may be reduced to a pH that is above the pKa of the pectin and below the pI of cashew protein, which may create opposite charges on the pectin and protein. This pH reduction may result in a pH reduced stable composition. In some embodiments, the pH of the pH reduced stable composition may be elevated to a pH above the pI of the protein following the initial reduction of pH to below the pI of the protein, thereby producing a pH elevated stable composition. This pH adjustment may, without being bound by theory, alter the conformation of a protein and pectin coacervate and contribute to system stability through electrostatic repulsion.

### BRIEF DESCRIPTION OF THE DRAWINGS

FIG. 1 shows particle size distribution of stable compositions in accordance with the present disclosure;

FIG. 2 shows destabilization kinetics of stable compositions in coffee in accordance with the present disclosure;

FIG. 3 shows foaming height of stable compositions prior in accordance with the present disclosure;

FIG. 4A illustrates coffee and creamer with feathering present in accordance with the present disclosure;

FIG. 4B illustrates coffee and creamer with feathering absent in accordance with the present disclosure.

### DETAILED DESCRIPTION

Unless otherwise defined, all technical and scientific terms used herein have the same meaning as commonly understood by one of ordinary skill in the art to which this invention pertains. Although methods and materials similar or equivalent to those described herein can be used to practice the invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting. All references to ratio and percent are by weight, unless otherwise indicated. The details of one or more embodiments of the invention are set forth in the accompanying drawings and the description below. Other features, objects, and advantages of the invention will be apparent from the description and drawings, and from the claims.

In the specification and in the claims, the terms “including” and “comprising” are open-ended terms and should be interpreted to mean “including, but not limited to . . . ” These terms encompass the more restrictive terms “consisting essentially of” and “consisting of.”

It must be noted that as used herein and in the appended claims, the singular forms “a”, “an”, and “the” include plural reference unless the context clearly dictates otherwise. As well, the terms “a” (or “an”), “one or more” and “at least one” can be used interchangeably herein. It is also to be noted that the terms “comprising”, “including”, “characterized by” and “having” can be used interchangeably.

As used herein, the term “ppm” shall be taken to mean “parts per million”. One gram in 1 liter is 1000 ppm and one thousandth of a gram (0.001 g) in 1 liter is one ppm.

As used herein, the term “x % (w/w)” “x % w/w” is equivalent to “x g per 100 g”. Unless indicated otherwise, all % value shall be taken to indicate x % w/w.

In the context of this application, the term “at least” also includes the starting point of the open range. For example, an amount of “at least 95.00% w/w” means any amount equal to 95.00 percentage by weight or above.

In the context of this application, unless otherwise provided, amounts refer to amounts by weight.

As used herein the term “vegetable” shall be taken to mean edible parts of a plant including but not limited to vegetables, fruits, flowers, stems, seeds, leaves and roots.

As used herein the term “plant-based” shall be taken to mean a composition or product which comprises vegetable, plant or plant-derived matter but does not comprise animal or animal-derived matter including but not limited to dairy, egg, fish, shellfish, meat, dairy milk and insects.

As used herein the adjective “dairy” shall be taken to mean a composition or product comprises or consists of mammalian milk matter, i.e. the lacteal secretion obtainable by milking.

As used herein the terms “free” or “free from” shall be taken to mean a composition or product which preferably does not contain a given substance but where trace amounts or contaminants thereof may be present.

As used herein the terms plant-based alternative, analog or substitute shall be taken to mean a plant-based food or beverage composition that is formulated to simulate the organoleptic and/or nutritional qualities of an equivalent non-plant-based product.

The present disclosure relates to stable compositions designed for use, in some embodiments, in hot, acidic beverages where the stable compositions may have an enhanced physical stability resulting from a combination of a protein and a pectin. In some embodiments, the protein may be a cashew protein, and the pectin may be a high ester sugar beet pectin. Stabilization for a stable composition may be accomplished by combining protein and pectin in accordance with the methods of the present disclosure. In some embodiments, the protein may be a plant-based protein. In some embodiments, the protein source may be a protein-containing extract, a protein-containing concentrate, a protein-containing liquid or other protein containing material. In some embodiments, the protein source may be a plant-matter concentrate. In some embodiments, a plant-matter concentrate may include a plant-matter milk concentrate, a plant-matter protein concentrate and a plant-matter protein isolate. In some embodiments, a plant-matter concentrate may be a cashew concentrate, which may include a cashew protein-containing concentrate such as a cashew milk concentrate, a cashew protein concentrate and a cashew protein isolate. In some embodiments, the present disclosure may include only three ingredients, including water, protein and pectin and may be free of buffering agents, emulsifiers, oils, gums or other stabilizing agents. In some embodiments, the present disclosure may include only three ingredients, including water, protein-containing concentrate and pectin.

Stable compositions of the present disclosure may alternatively be referred to as liquid bases or creamer compositions. Enhanced stability of stable compositions of the present disclosure may be achieved by combining protein and pectin in appropriate amounts and adjusting the pH to increase stability. This process for producing stable compositions may, without being bound by theory, create conditions for formation of a more stable coacervate formed between the protein and the pectin.

The process of the present disclosure may generally include, in some embodiments, the steps of dispersing a pectin in water to produce a pectin mixture; mixing until the pectin mixture is homogenous; adding a protein, which may be in the form of a concentrate, to the pectin mixture to produce a protein and pectin mixture; adjusting a pH of the protein and pectin mixture by reducing a pH of the protein and pectin mixture to above a pKa of the pectin, which may be an overall pKa of the pectin, and below a pI of a protein, which may be an overall pI of the protein, to produce a pH reduced protein and pectin mixture, which may also be referred to herein as a pH reduced stable composition; and then elevating the pH of the pH reduced stable composition to produce a pH elevated stable composition. Stable compositions of the present disclosure may include pH reduced stable compositions and pH elevated stable compositions. In some embodiments, a stable composition may include a combination of cashew protein and pectin, which may be referred to herein as a cashew protein and pectin stable composition, or a combination of native cashew protein and pectin, or a combination of cashew protein-containing concentrate prepared by aqueous extraction as described herein and pectin. In some embodiments, a stable composition may include a combination of protein and pectin, which may be referred to herein as a protein and pectin stable composition, or a combination of native protein and pectin, or a combination of protein-containing concentrate prepared by aqueous extraction as described herein and pectin.

More specifically, in some embodiments of the present disclosure, sugar beet pectin may be dispersed in water and mixed for 10 minutes until achieving homogeneity. Subsequently, a cashew protein-containing concentrate may be introduced. The pH of the mixture of pectin and cashew protein-containing concentrate may be in an initial range of about 6 to 8, or, in some embodiments 6.6. The pH may then be reduced to 4.9, or just below the pI of the cashew protein, which may, in some embodiments, be in a range between approximately 3 to 5.5, by using food grade citric acid (50% w/v). In some embodiments, the pI of cashew protein, which is known in the art, may be approximately 4.9 to 5.1, which may be above the pH of the mixture after reducing the pH of the protein and pectin mixture. After reducing the pH of the protein and pectin mixture, the pH may be set above a pectin pKa and below a cashew protein pI, thereby producing a pH reduced stable composition. This strategic reduction of pH may result in a net negative charge on the pectin and a net positive charge on the protein, thereby, without being bound by theory, potentially maximizing the formation of coacervate through electrostatic interaction.

Surprisingly, it has been found that increasing the pH of the pH reduced stable composition above the pI of the protein increased the stability of the composition. The resulting pH elevated stable composition is more stable than a pH reduced stable composition when added to a hot, acidic beverage such as coffee. To elevate the pH, in some embodiments, a base such as potassium hydroxide at a concentration of 0.0785% w/w may be added to the pH reduced stable composition to increase the pH to about 6 to 6.15. Elevation of the pH, without being bound by theory, may alter the conformation of the protein and contribute to system stability through electrostatic repulsion.

In accordance with the present disclosure, stable compositions may include pH reduced stable compositions and pH elevated stable compositions.

The present disclosure includes, in some embodiments, wherein a protein, which may be from a concentrate, may be comprised of non-denatured (native), or substantially non-denatured protein.

The present disclosure includes, in some embodiments, wherein the protein may be comprised of denatured, or substantially denatured protein.

The present disclosure includes, in some embodiments, wherein the protein source is a cashew concentrate, which may also be a cashew milk concentrate.

The present disclosure includes, in some embodiments, wherein the pectin is a beet pectin or a sugar beet pectin.

The present disclosure includes, in some embodiments, wherein the pectin is at least one of a high ester pectin, including a high ester beet pectin, having a 55 DE to 60 DE.

The present disclosure includes, in some embodiments where a protein and pectin mixture, prior to pH adjustment, has a pH of approximately 6.6, or between approximately 6 and 8.

The present disclosure includes, in some embodiments, wherein a pH of a pH reduced protein and pectin mixture, which may also be referred to herein as pH reduced stable composition, is approximately 4.9, or between approximately 3.7 and 5.4, or between approximately 3 and 5.5.

The present disclosure includes, in some embodiments, wherein the pH of the protein and pectin mixture is reduced to produce a soluble or suspended material in a pH reduced stable composition.

In some embodiments, the pH reduced protein and pectin mixture, which may also be referred to herein as a pH reduced stable composition, may be added to a beverage to provide a beverage additive, such as a creamer, having increased stability and reduced feathering in hot, acidic beverages such as coffee.

The present disclosure includes, in some embodiments, elevating the pH of the pH reduced stable composition, after producing the pH reduced stable composition, to stabilize a soluble or suspended material and to produce a pH elevated protein and pectin mixture, which may also be referred to herein as a pH elevated stable composition.

In some embodiments, a pH of a pH elevated stable composition is approximately between 6 and 6.15, or between approximately 5.5 and 7.5, or between approximately 5.5 and 8.0.

The present disclosure includes, in some embodiments, elevating the pH of the pH reduced stable composition to stabilize the soluble or suspended material in the pH reduced stable composition by adding a base as a pH control agent.

The present disclosure includes, in some embodiments, elevating the pH of the pH reduced stable composition by adding potassium hydroxide.

The present disclosure includes, in some embodiments, elevating the pH of the pH reduced stable composition to above the pI of the protein.

The present disclosure includes, in some embodiments, elevating the pH of the pH reduced stable composition to above the pH of the protein in a protein-containing concentrate.

The present disclosure includes, in some embodiments, a stable composition, comprising: a protein and a pectin; wherein the pH of the stable composition is higher than the pKa of the pectin.

The present disclosure includes, in some embodiments, wherein the stable composition contains a soluble or suspended material; and wherein the soluble or suspended material may be a chemical compound including a protein, which may be from a protein-containing concentrate, and a pectin.

In some embodiments, a stable composition in accordance with the present disclosure may include water, cashew protein-containing concentrate, pectin, potassium hydroxide and natural flavors.

In some embodiments, a stable composition in accordance with the present disclosure may include water at a concentration of approximately 86% w/w, or of between approximately 75% and 86% w/w, or between approximately 60% and 86% w/w, or between approximately 40% and 89.6% w/w.

In some embodiments, a stable composition in accordance with the present disclosure may include protein-containing concentrate at a concentration of between approximately 12.5%, or between approximately 12.5% to 24% w/w, or between approximately 10% and 40% w/w, or between approximately 10% and 60% w/w.

In some embodiments, a stable composition may have a protein concentration of approximately 0.54%, or between approximately 0.4% and 1% w/w, or between approximately 0.3% and 5% w/w.

In some embodiments, a stable composition in accordance with the present disclosure may include pectin at a concentration of approximately 0.8% w/w, or between approximately 0.5% and 1% w/w, or between approximately 0.6% w/w to 1% w/w, or between approximately 0.1% and 2% w/w.

The present disclosure includes, in some embodiments, wherein a ratio of protein to pectin in a stable composition is approximately 0.64, or between approximately 0.5 and 2 w/w, or between approximately 0.3 and 3.33 w/w, or between approximately 0.875 and 1 w/w.

In some embodiments, a stable composition may have a carbohydrate composition of approximately 5%, or between approximately 4% and 14% w/w, or between approximately 0% and 20% w/w.

In some embodiments, a stable composition may have a dietary fiber concentration of approximately 1% w/w, or between approximately 1 and 2% w/w, or between approximately 0% and 5% w/w.

In some embodiments, a stable composition may have a soluble fiber concentration of approximately 0.16%, or between approximately 0 and 1% w/w, or between approximately 0% and 5% w/w.

In some embodiments, a stable composition may have a sugar concentration of approximately 0.4% w/w, or between approximately 0% and 10% w/w.

In some embodiments, a stable composition may have an ash concentration of approximately 1%, or between approximately 1.0% and 2.0% w/w, or between approximately 0% and 2% w/w.

In some embodiments, a stable composition may have an oil concentration of approximately 2.68% w/w, or between approximately 2% and 5% w/w, or between approximately 0% and 30% w/w.

In some embodiments, a stable composition in accordance with the present disclosure may include natural flavors at a concentration of approximately 0.8%, or between approximately 1.25% and 1.75% w/w, or between approximately 1.0% and 2.0% w/w.

In some embodiments, a stable composition in accordance with the present disclosure may include potassium hydroxide at a concentration of between approximately 0.06% w/w and 0.1% w/w, or between approximately 0.07% w/w and 0.09% w/w, or between approximately 0.075% w/w and 0.085% w/w, or generally in an amount sufficient to produce a suitable pH for the purposes of the present disclosure.

In some embodiments, the viscosity of the creamer at 22° C. may be approximately 25 cPs/mPa, or between approximately 20 and 30 cPs/mPa, or between approximately 5 and 50 cPs/mPa. The viscosity of stable compositions was measured using Brookfield DV-1 viscosimeter using spindle 1 at 20 rpm and approximately 22° C.

In some embodiments of a stable composition in accordance with the present disclosure, the ratio of cashew protein to sugar beet pectin may be about 0.3-3.33 w/w; the pectin concentration may be about 0.1% to 2% w/w, the protein concentration may be about 0.3%-5% w/w; the carbohydrate concentration may be about 0% to 20% w/w; the dietary fiber concentration may be about 0% to 5% w/w; the soluble fiber concentration may be about 0% to 5% w/w; the sugar concentration may be about 0% to 10% w/w; the ash concentration may be about 0 to 2%; and the oil concentration may be about 0% to 30% w/w.

In some embodiments, a stable composition in accordance with the present disclosure may include water at a concentration of approximately 73.86% w/w, cashew protein-containing concentrate at a concentration of approximately 23.76% w/w, sugar beet pectin at a concentration of approximately 0.8% w/w, potassium hydroxide at a concentration of 0.078% w/w and natural flavors at a concentration of approximately 1.5% w/w.

The present disclosure may include, in some embodiments, a stable composition comprising a coacervate; wherein the coacervate is formed between a protein, wherein the protein source may be a protein-containing concentrate, and a pectin.

In some embodiments, the protein is a plant or dairy protein or combinations thereof.

In some embodiments, the protein source is grains, nuts or seeds or combinations thereof.

In some embodiments, the protein source is a nut protein-containing concentrate.

In some embodiments, the protein source is from a member of the Anacardiaceae family.

In some embodiments, nuts are selected from the group consisting of almonds, cashews, pecans, macadamias, hazelnuts, pistachio, walnuts or combinations thereof.

In some embodiments, the protein source may be plant protein source such as legumes, including pulse or pulses. In other embodiments, the pulses are selected from the group consisting of split peas, field peas, dry peas, lentil, chickpeas, garbanzo bean, konda, navy bean, white navy bean, white pea bean, pea bean, cow pea, horse bean, haricot, pinot bean, mottled bean, small red bean, red Mexican bean, kidney bean, black bean, black turtle bean, cranberry bean, roman bean, speckled sugar bean, lima bean, haba bean, Madagascar bean, green gram, mung bean, green bean, black gram, urad dal, soy, faba and/or lupin.

In other embodiments, the plant-matter comprises plant protein sources from tubers or cereals such as potato, rice and/or wheat.

In some embodiments, seeds may be selected from the group consisting of hemp, pumpkin, quinoa, sesame, tiger nut, flax, chia, sunflower, coconut or combinations thereof.

In some embodiments, cereals may be selected from the group consisting of wheat, rye, spelt, barley, oat, millet, sorghum, rice, teff and combinations thereof.

In some embodiments, the protein-containing concentrate is a cashew protein-containing concentrate, a cashew protein concentrate, or a cashew protein isolate.

In some embodiments, the protein-containing concentrate is a cashew protein-containing concentrate produced in accordance with the methods for processing of grain described in U.S. Pat. No. 7,678,403 to Mitchell and Mitchell and U.S. Pat. Pub. No. 20220217994 to Mitchell Ellis, which are herein incorporated by reference in their entirety. Generally, using cashew as an example, this process may include an aqueous extraction process including the steps of adding water to the cashew nut, wet milling the nut to produce a slurry, sifting the slurry, to produce a cashew protein-containing concentrate.

More specifically, to produce protein-containing concentrates used for testing in the present disclosure, and in some embodiments generally, an aqueous extraction method of producing a protein-containing concentrate from, for example, cashews, may include, adding cashews to water and wet milling to produce a cashew slurry. Wet milling may be performed using a Silverson rotor stator type mill. Wet milling may be conducted for a suitable period, as would be understood by one of ordinary skill in the art, and, in some embodiments, longer or shorter extraction periods may be utilized.

After aqueous wet milling the cashews, an extract may be separated from at least a portion of an insoluble byproduct by sifting through a mesh. Insoluble fibers and other insoluble material may be removed during a sifting step. Sifting may remove unwanted impurities that may give the cashew protein-containing concentrate an undesirable taste, texture or appearance. In some embodiments, the cashew slurry may be sifted using a US 120 mesh screen. Other methods of separating insoluble material from a solution, such as centrifugation and decanting, may, in some embodiments, be utilized as would be known to one of ordinary skill in the art.

Enzymes may be used to aid in processing. For example, liquefaction may be accomplished using an alpha-amylase enzyme having dextrinizing activity to yield a liquefied slurry. Such enzymes may include amylases or other carbohydrases known in the art of food processing. Enzyme co-factors including calcium chloride and calcium carbonate may be added to the liquefaction reaction promote enzyme activity, as would be known to one of ordinary skill in the art.

The filtrate cashew milk may be heated at 150° F. for 30 minutes for liquefaction. To deactivate the enzyme, the cashew milk may be heated to approximately 190°-195° F. An evaporator may be used to produce a cashew protein-containing concentrate from the cashew milk, wherein the cashew protein-containing concentrate may have a composition as described in Example 1.

A group of protein-containing concentrates produced according to the aqueous extraction method described above were tested in accordance with the present disclosure. Oat and almond protein-containing concentrates were produced according to the aqueous extraction method described above. Compositions produced in accordance with the methods of the present disclosure using oat or almond protein-containing concentrates as protein sources were not effective over the observation period described in Example 4 in producing a pH reduced stable composition and a pH elevated stable composition that would inhibit feathering when added to coffee. Surprisingly, however, cashew protein-containing concentrate, when prepared as described above and used to produce a stable composition in accordance with the present disclosure, was effective over the period of observation described in Example 4 in producing a pH reduced stable composition and a pH elevated stable composition that would inhibit feathering when added to coffee.

Aqueous extraction as described herein may result in a protein-containing concentrate where the protein has a native, or substantially native, or more native, structure than other methods of extraction. Protein-containing concentrates that include proteins in their native state may, in some embodiments, have superior functionality with regard to stability of the stable compositions of the present disclosure. In some embodiments, conditions that could lead to the full or partial denaturation of protein, such as high temperature, acidic or basic conditions, high pressure, mechanical force and other conditions that may lead to full or partial denaturation of the protein, may, in some embodiments, be avoided in the present disclosure. In some embodiments, water may be the only solvent used during extraction to produce a protein-containing concentrate.

In some embodiments, the present disclosure may include other methods of producing a protein-containing concentrate. These methods may include alkaline extraction, isoelectric precipitation, salt extraction, enzymatic extraction, ultrasound-assisted extraction, dry fractionation and other methods of protein extraction known to one of ordinary skill in the art.

In some embodiments, the pectin is a beet pectin.

In some embodiments, the pectin is a sugar beet pectin.

In some embodiments, the pectin is at least one of a high ester pectin.

In some embodiments, a foamability of at least one of a pH reduced stable composition and a pH elevated stable composition produced in accordance with the present disclosure is improved.

In some embodiments of the present disclosure, there is provided a method of preparing a beverage composition, comprising:
(i) providing a beverage composition base; and
(ii) adding a stable composition to the beverage composition base.

In some embodiments, a stable composition includes a composition intended to be added to a beverage or food composition, such as coffee, tea, cocoa or soup, to impart specific characteristics such as color (e.g. whitening effect), thickening, flavor, texture, and other desired characteristics. In some embodiments, a stable composition may be intended to substitute for milk or cream beverages or food compositions.

In some embodiments, a stable composition may be non-dairy. A non-dairy stable composition may be a stable composition containing no substances derived from dairy products (e.g. casein).

In some embodiments, a stable composition may be vegan. A vegan stable composition may be a stable composition containing no substances derived from animals (including e.g. substances derived from eggs or dairy products).

In some embodiments, a stable composition is a beverage creamer. A beverage creamer may be a stable composition intended to substitute for milk or cream in coffee, tea, cocoa or other beverages. In some embodiments, a stable composition is a coffee creamer, a tea creamer or a cocoa creamer.

A stable composition of the present disclosure may comprise pectin, which may be a sugar beet pectin.

A stable composition may comprise pectin in any suitable amount. Pectins, also known as pectic polysaccharides, are rich in galacturonic acid. Pectins may include homogalacturonan, rhamnogalacturonan-I, and rhamnogalacturonan-II structural elements. Homogalacturonan is a homopolymer of up to 200 units of a (1-4)-linked D-galacturonic acid. Rhamnogalacturonan-I pectins contain a backbone of the repeating disaccharide: 4)-α-D-galacturonic acid-(1,2)-α-L-rhamnose-(1. Rhamnogalacturonan-II is a less frequent, complex, highly branched polysaccharide.

The C6 carboxyl groups of galacturonic acid may be esterified with methanol. The degree of esterification (DE) is the percentage of galacturonic acid which is esterified with methanol and has a maximum value of 100% % (since each galacturonic acid can be esterified once).

The O2 and/or O3 hydroxyl groups of the galacturonic acid may be acetylated. The degree of acetylation (DAc) is the percentage of galacturonic acid which is acetylated and can have a value of >100% (since each galacturonic acid can be acetylated more than once).

The degree of esterification and the degree of acetylation may be determined by any method known to the skilled person. For example, the degree of esterification and the degree of acetylation may be determined using the following formula:

Degree of esterification=(millimoles methanol/millimoles uronic acid)×100

Degree of acetylation=(millimoles acetic acid/millimoles uronic acid)×100

where the content of uronic acid is determined using a colorimetric procedure and the methanol and acetic acid content is determined by HPLC following alkali treatment of the pectin sample.

The amount, structure and chemical composition of pectin differs among plants, within a plant over time, and in various parts of a plant. For example, the degree of esterification can range from about 10% or lower to about 80% or higher and the degree of acetylation can vary from about 2% or lower to about 20% or higher.

Pectins with a low DE (<50%) may form a gel through hydrogen bonding and hydrophobic interactions in acidic conditions and in the presence of sugars. This generally requires a solid content of >60%. Pectins with a high DE (>50%) gelate in the presence of divalent cations such as Ca2+. This may occur in much lower total solid content (10-70%).

The pectin used in the present disclosure may be a high DE pectin. Suitably, the pectin has a degree of esterification (DE) of at least about 50%, or at least about 55%, or from about 50% to about 60%, or about 55%.

Pectins with a high DAc (e.g. >10%) may have a reduced gelling capacity but may have improved emulsifying ability. The hydrophobic nature of the acetylated groups may coat the oil interface and reduce interfacial tension, whilst the carbohydrate chain increases viscosity and stabilizes the emulsion. Hydration of latter chains may contribute by forming a hydrated layer to increase steric stabilization.

In some embodiments, the pectin used in the present disclosure may be a high DAc pectin. In some embodiments, the pectin may have a degree of acetylation (DAc) of at least about 10%, or at least about 15%, or at least about 20%. In some embodiments, the pectin may have a degree of acetylation (DAc) of about 10% to about 30%, or from about 14% to about 26%, or from about 20% to about 25%.

In some embodiments, the pectin used in the present disclosure may be a high DE and a high DAc pectin. For example, the pectin suitably has a degree of esterification (DE) of at least about 50% and a degree of acetylation (DAc) of at least about 10%.

In some embodiments, the pectin may have a molecular weight of at least about 30,000 Da, at least about 40,000 Da, at least about 50,000 Da, or at least about 60,000 Da.

In some embodiments, the pectin may have a viscosity in a 2% w/w mixture of from about 10 cPs/mPa to about 150 cPs/mPa.

In some embodiments, the pectin used in the present disclosure comprises or consists of sugar beet pectin. In some embodiments, the pectin used in the present disclosure is sugar beet pectin. In some embodiments, a stable composition in accordance with the present disclosure does not comprise any pectin other than sugar beet pectin.

Sugar beet pectin can be extracted from sugar beet pulp by any method known to the skilled person.

In some embodiments, sugar beet pectin used in the present disclosure may have a degree of esterification (DE) of at least about 50%, or at least about 55%, or from about 50% to about 60%, or about 55%. In some embodiments, the sugar beet pectin may have a degree of acetylation (DAc) of about 10% to about 30%, or from about 14% to about 26%, or from about 20% to about 25%.

In some embodiments, other pectins may be used which have the same or similar properties (including DE and DAc) as sugar beet pectin.

For example, modified pectin may be used. Pectins with a low DE and/or low DAc may be esterified and/or acetylated using any method known to the skilled person to arrive at a pectin with similar properties to sugar beet pectin.

A stable composition may comprise a one or more pH control agent in any suitable amount. Suitably, a stable composition may comprise the one or more pH control agent in an amount of at least about 0.01% w/w, or at least about 0.1% w/w. Suitably, a stable composition may comprise the one or more pH control agent in an amount of from about 0.01% w/w to about 5% w/w, or from about 0.1% w/w to about 5% w/w.

As used herein, a pH control agent is an additive used to change or maintain the pH of a composition and includes bases, acids, neutralizing agents, and buffering agents. Any suitable pH control agent may be used, for example a base.

In some embodiments, a stable composition comprises a base. The base may be any suitable organic or inorganic base, or a combination thereof. For example, the base may be a carbonate salt or a solution thereof, a bicarbonate salt (hydrogen carbonate salt) or a solution thereof, or a hydroxide salt or a solution thereof, or a combination thereof. In some embodiments, the base may be used as a pH control agent.

In some embodiments, a stable composition comprises a base selected from one or more of: calcium carbonate, ammonium carbonate, magnesium carbonate, potassium carbonate, sodium carbonate, ammonium hydrogen carbonate, magnesium hydroxide carbonate, potassium hydrogen carbonate, sodium hydrogen carbonate, sodium sesquicarbonate, ammonium hydroxide, calcium hydroxide, magnesium hydroxide, potassium hydroxide, and sodium hydroxide; or a solution thereof.

In some embodiments, a stable composition may comprise an oil component in any suitable amount. In some embodiments, a stable composition is free of oil. In some embodiments, the stable composition comprises an oil component in an amount of about 0% to 30% w/w, or at least about 0.1% w/w, at least about 1% w/w, at least about 3% w/w, at least about 5% w/w, at least about 8% w/w, at least about 10% w/w, at least about 12% w/w, at least about 15% w/w, or at least about 20% w/w. In some embodiments, a stable composition comprises the oil component in an amount of from about 0.73% w/w to about 3.68% w/w, from about 0.5% w/w to about 5% w/w, from about 0.1% w/w to about 10% w/w, from about 0.001% w/w to about 20% w/w, or from about 0.001% w/w to about 50% w/w, or from about 2% to about 5% w/w. Any oil which is suitable may be included as an oil component.

In some embodiments, a stable composition may comprise a protein component in any suitable amount. In some embodiments, a stable composition comprises the protein component in an amount of about 1% to 20% w/w, or at least about 0.1% w/w, at least about 0.2% w/w, at least about 0.3% w/w, at least about 0.5% w/w, at least about 1% w/w, at least about 2% w/w, at least about 3% w/w, at least about 4% w/w, at least about 5% w/w, at least about 7% w/w, or at least about 10% w/w. In some embodiments, a stable composition comprises a protein component in an amount of from about 0.0.3% w/w to about 2% w/w, from about 2% w/w to about 4% w/w, from about 0.001% w/w to about 5% w/w, from about 0.1% w/w to about 10% w/w, or from about 0.1% w/w to about 20% w/w. In some embodiments, a stable composition comprises a protein component in and amount of from about 0.3% to 5%. Any protein which is suitable for the purpose of the present disclosure may be used as a protein component, including plant protein, plant protein from grains, nuts or seeds and plant protein from cashews.

In some embodiments, a stable composition may contain carbohydrates in any suitable amount, for example between approximately 0% and 20% w/w, or between approximately 0.4% and 2.2% w/w, or between approximately 0.001% and 5% w/w, or between approximately 4 and 14% w/w.

A stable composition may contain dietary fiber in any suitable amount, for example in some embodiments between approximately 0% to 5% w/w, 0.1% and 5% w/w, or between about 1 and 2% w/w.

A stable composition may contain soluble fiber in any suitable amount, for example in some embodiments between approximately 0% and 5% w/w, or 0.0% and 1% w/w.

A stable composition may contain sugar in any suitable amount, for example in some embodiments between approximately 0% and 10% w/w, or 0.1% and 5% w/w.

The present disclosure may comprise a beverage including a stable composition as described herein. A beverage may be any suitable beverage such as a coffee, tea, or cocoa beverage. A beverage composition may be a ready-to-drink beverage or a ready-to-use beverage.

The present disclosure further provides a powdered coffee, tea, or cocoa beverage composition comprising coffee, tea, or cocoa and a powdered stable composition according to the disclosure. By a powdered coffee, tea, or cocoa beverage composition is meant a powdered composition suitable for providing a coffee, tea, or cocoa beverage by dissolution in a liquid, preferably water, such as instant coffee, instant tea, or instant cocoa. Powdered coffee, tea, or cocoa beverage compositions comprising soluble coffee, tea, or cocoa in combination with powdered creamer are well known in the art. Powdered coffee, tea, or cocoa beverages may further comprise sweeteners, e.g. sugar, and flavors. In some embodiments, the disclosure relates to a powdered coffee beverage comprising soluble coffee and a powdered stable composition according to the disclosure. In some embodiments, the disclosure relates to a powdered tea beverage comprising soluble tea and a powdered stable composition according to the disclosure. In some embodiments, a powdered stable composition may be produced by spray drying or freeze drying a liquid stable composition; or by using other methods of producing a powder as would be known to one of ordinary skill in the art.

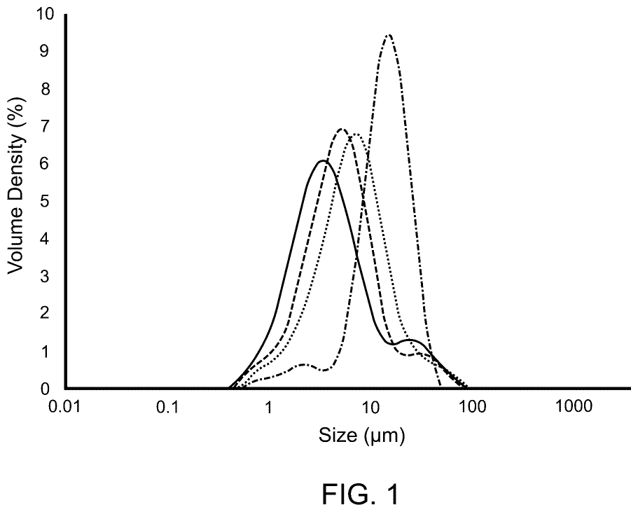

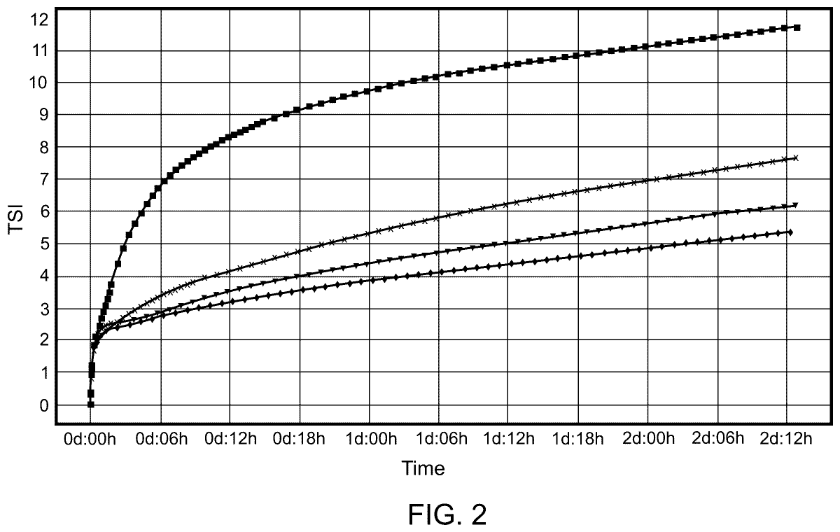

FIG. 1 illustrates the particle size distribution in a stable composition alone, prior to combining with a beverage, for various treatments, where: (i) control sample with no pectin (dash-dot-dash line), (ii) treatment with 0.3% pectin with pH adjustment (dotted line), (iii) treatment with 0.8% pectin without pH adjustment (dashed line), and (iv) treatment with 0.8% pectin with pH adjustment (solid line). The De Brouckere mean diameters for these samples are 16.753 μm, 10.230 μm, 8.131 μm, and 8.440 μm, respectively. The reduced particle size distribution observed in the sample treated with 0.8% pectin and pH adjustment may, without being bound by theory, indicate the formation of more stable complex coacervates, which exhibit enhanced physical stability (see also FIG. 2). Reduced particle size distribution is correlated with increased stability of the composition when added to a beverage such as coffee.

Particle size distribution was measured using laser diffraction with a ZETASIZER NANO ZS (Malvern Instruments, UK). Deionized (DI) water was used as the dispersant. The refractive indices were set to 1.330 for the dispersant phase and 1.810 for the dispersed phase. An obscuration level of 7.38% was maintained during measurement. Volume-based particle size distribution was determined and plotted using the Mie scattering model.

FIG. 2 depicts the destabilization kinetics of various samples of stable compositions after addition to coffee, as described in Example 4, where the samples include: (i) control sample with no pectin (square), (ii) treatment with 0.3% pectin with pH adjustment (x), (iii) treatment with 0.8% pectin without pH adjustment (triangle), and (iv) treatment with 0.8% pectin with pH adjustment (diamond). The total stability index (TSI) is inversely proportional to the stability of the sample, with higher TSI values indicating decreased stability. As illustrated, the control sample exhibits significantly lower stability compared to the pH reduced stable composition and the pH elevated stable composition (0.8% pectin with pH adjustment), which demonstrates enhanced stability which, without being bound by theory, may be the result of formation of complex coacervates.

Colloidal stability under acidic conditions was evaluated using TURBISCAN technology (FORMULACTION, France), which operates based on Static Multiple Light Scattering (SMLS). Samples were loaded into standard TURBISCAN cells and analyzed at 25° C. Transmission and backscattering signals were recorded over a 24-hour period to monitor particle migration and aggregation phenomena. The TURBISCAN Stability Index (TSI), calculated from variations in signal intensity, was used as a quantitative measure of instability. Higher TSI values indicate lower colloidal stability.

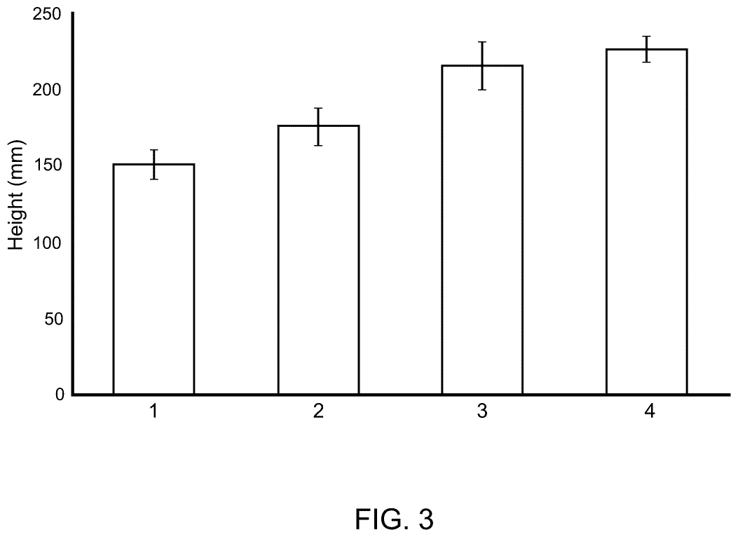

FIG. 3 depicts the foaming height of various samples of a stable composition alone, prior to combination with a beverage, including: a control sample with no pectin (1), treatment with 0.3% pectin with pH adjustment (2), treatment with 0.8% pectin without pH adjustment (3), and treatment with 0.8% pectin with pH adjustment (4). Stable compositions in accordance with the present disclosure may improve foam quality and foamability. It may be that, without being bound by theory, coacervates formed in stable compositions of the present disclosure result in increased foam quality and foamability.

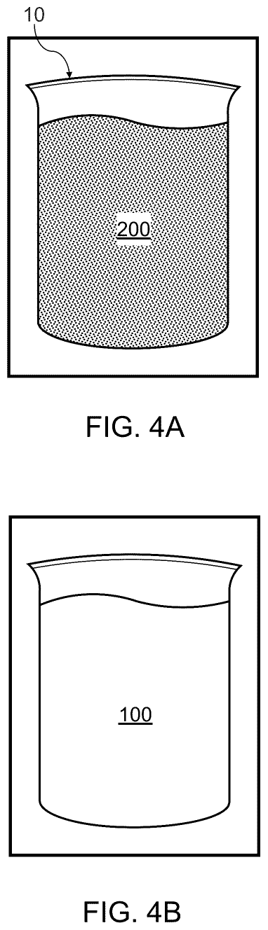

FIG. 4A shows a representative illustration of coffee and feathered creamer 200, where aggregation and precipitation, or feathering, is observed when the creamer is added to the beverage. FIG. 4B shows a representative illustration of coffee and creamer without feathering 100. In some embodiments, aggregation and precipitation of cashew protein may be present when a pH reduction step and/or a pH elevation step is not performed in the process of the present disclosure.

### EXAMPLES

### Example 1

Pectin was purchased from CPKELCO. The pectin was in powder form. The product was labeled as GENU BETA E440 Pectin, having a CAS number: 9000-69-5. GENU BETA pectin is a high ester pectin extracted from sugar beet pulp. The degree of acetate was between 14-26%. The average molecular weight of the pectin was approximately not less than 60,000 Da. The pH of a 1% mixture of the pectin was between approximately 3.0 and 4.0. The viscosity at 2% w/w was between 10 and 150 cPs/mPa. The degree of esterification was about 55%.

Cashew protein-containing concentrate (CPC) was provided by GNS under the tradename CASHEWLIFE. The CPC was in liquid form. The product resource code number was 135013. The CPC was prepared generally as described herein and according to the method described in U.S. Pat. No. 7,678,403 to Mitchell and Mitchell, which is herein incorporated by reference in its entirety.

The total solids concentration of the CPC was between 16.0-20.0%. The protein concentration of the CPC was approximately 24% w/w on a dry substance basis. The pH of the liquid CPC was approximately between 6.2 and 7.8. The CPC had a pI of approximately 5-5.1. The CPC, per 100 g dsb, had total fat of 46 g (8 g of saturated fat and Og of trans fat), 0 mg cholesterol, 30 mg sodium, 580 mg potassium, 27 g total carbohydrate (5 g dietary fiber, total sugar 7 g), 24 g protein, and 2.8 g ash.

To produce a stable composition, pectin was dispersed in water and mixed for 10 minutes until a homogenous mixture was produced. Pectin was added to a concentration of 0.8% w/w. CPC was added to the aqueous pectin mixture to a cashew protein-containing concentrate of approximately 12.5% w/w and mixed to produce a protein and pectin mixture with a pH of approximately 6.6. The pH was then adjusted to 4.9 by adding food grade citric acid at a concentration of 50% w/v to produce a pH reduced stable composition. Potassium hydroxide at a concentration of 0.0785% w/w was then added to the pH reduced stable composition to elevate the pH to between about 6 and 6.15 in order to produce a pH elevated stable composition. To produce a pH reduced stable composition, the last step involving elevating the pH was omitted from the process. To produce a protein and pectin stable composition the last two steps described above, involving pH reduction and pH elevation, were omitted from the process.

### Example 2

The foaming properties of the cashew-based stable compositions were assessed using a NESPRESSO AEROCCINO+ automatic electric milk frother (Model 3192). A 100 mL aliquot of a stable composition, pre-chilled to approximately 4 to 5° C., was added to the frother and processed using the “hot foam” setting for 70 seconds. The NESPRESSO AEROCCINO+ includes a cylindrical stainless-steel container having an internal diameter of approximately 3.5 inches, with the total volume capacity being 240 mL. It is equipped with a magnetically driven electric whisk at the base. During operation, the “hot foam” setting heats the sample to 64±4° C. while simultaneously agitating it to promote foam formation. Upon completion, the frothed sample was immediately transferred into a graduated beaker, and the foam height was recorded.

For the present disclosure, foamability may be calculated using the following equation: foamability=(hf−hi)/hi×100. Hf is the final foam height (mm) and Hi is the initial liquid height (mm) prior to foaming.

### Example 3

Coffee was prepared by brewing water and LAVAZZA espresso to a pH of approximately 4.7 to 4.8. The coffee was prepared using a standardized ratio of 2 tablespoons (approximately 30 g) of ground coffee per 6 fluid ounces (177 mL) of tap water. Brewing was performed using a MR. COFFEE electric drip coffee maker. The machine operated within a temperature range of 195-205° F. (40.5-96.1° C.), consistent with typical home brewing conditions. The brewed coffee was collected immediately after the drip cycle for subsequent evaluation.

### Example 4

In a glass beaker, stable compositions produced as described in Example 1 were added to coffee produced as described in Example 3. The ratio of stable composition to coffee was 30 g of liquid stable composition per 8 ounce of coffee. The combinations of stable composition and coffee were then mixed in a glass beaker. The product was then assessed for feathering, or aggregation, which was observed as particle formation through the sidewall of the beaker as generally illustrated in FIGS. 4A and 4B. Assessment consisted of visually observing the coffee and creamer for feathering over an observation period of about 8 to 10 minutes through the sidewall of the glass beaker. The time of observation was chosen to represent the typical period of time during which a consumer would drink a cup of coffee.

While embodiments of the present invention have been shown and described, various modifications may be made without departing from the scope of the present invention. The invention, therefore, should not be limited, except to the following claims, and their equivalents.

What is claimed is:

1. A method, comprising:
dispersing a pectin in an aqueous liquid to produce a pectin mixture;
adding a protein to the pectin mixture to produce a protein and pectin mixture;
reducing a pH of the protein and pectin mixture to above a pKa of the pectin and below a pI of the protein to produce a pH reduced stable composition; and
elevating a pH of the pH reduced stable composition to above the pI of the protein to produce a pH elevated stable composition.

2. The method of claim 1, wherein a concentration of the pectin in the pH elevated stable composition is between approximately 0.1% and 2% w/w.

3. The method of claim 1, wherein a concentration of a protein in the pH elevated stable composition is between approximately 0.3%-5% w/w.

4. The method of claim 1, wherein a ratio of protein to pectin in the pH elevated stable composition is between approximately 0.3-3.33 w/w.

5. The method of claim 1, wherein a concentration of a protein-containing concentrate in the pH elevated stable composition is between approximately 10% w/w and 60% w/w.

6. The method of claim 1, wherein the pH elevated stable composition has a carbohydrate concentration is about 0% to 20% w/w; a dietary fiber concentration is about 0% to 5% w/w; a soluble fiber concentration is about 0% to 5% w/w; a sugar concentration is about 0% to 10% w/w; an ash concentration is about 0 to 2%; and an oil concentration is about 0% to 30% w/w.

7. The method of claim 1, wherein the pH of the protein and pectin mixture is between approximately 6 and 8.

8. The method of claim 1, wherein the pH of the pH reduced stable composition is between approximately 3 and 5.5.

9. The method of claim 1, wherein a pH of the pH elevated stable composition is between approximately 5.5 and 8.0.

10. The method of claim 1, wherein the protein is a cashew protein.

11. The method of claim 1, wherein the protein is a cashew protein in a native state.

12. The method of claim 1, wherein the protein is extracted by an aqueous extraction process.

13. The method of claim 1, wherein the pectin is a sugar beet pectin.

14. A method, comprising:
dispersing a pectin in an aqueous liquid to produce a pectin mixture; and
adding a protein to the pectin mixture to produce a protein and pectin mixture.

15. The method of claim 14, further comprising reducing a pH of the protein and pectin mixture to above a pKa of the pectin and below a pI of the protein to produce a pH reduced stable composition.

16. The method of claim 15, further comprising elevating a pH of the pH reduced stable composition to above a pI of the protein to produce a pH elevated stable composition.

17. The method of claim 14, wherein the protein is a cashew protein extracted by an aqueous extraction process.

18. A composition, comprising:
an aqueous liquid;
a pectin, wherein a concentration of the pectin is between approximately 0.1% and 2% w/w;
a protein, wherein a concentration of the protein is between approximately 0.3%-5% w/w; and
wherein a ratio of protein to pectin in the composition is between approximately 0.3-3.33 w/w.

19. The composition of claim 18, wherein a pH is between approximately 3 and 5.5.

20. The composition of claim 18, wherein a pH is between approximately 5.5 and 8.0.

21. The composition of claim 18, wherein the protein is at least one of a cashew protein.

22. The composition of claim 18, wherein the protein is a cashew protein in a native state.

23. The composition of claim 18, wherein the pectin is a sugar beet pectin.

24. The composition of claim 18, wherein the pectin is a high DE sugar beet pectin.

25. The composition of claim 18, further comprising a carbohydrate concentration at about 0% to 20% w/w; a dietary fiber concentration at about 0% to 5% w/w; a soluble fiber concentration at about 0% to 5% w/w; a sugar concentration at about 0% to 10% w/w; an ash concentration is about 0 to 2%; and an oil concentration at about 0% to 30% w/w.

26. The composition of claim 18, further comprising a coacervate; and
wherein the coacervate is formed between the protein and the pectin.
